(19) United States
(12) Patent Application Publication
(10) Pub. No.: US 2009/0160821 A1
(43) Pub. Date: Jun. 25, 2009

(54) ULTRASONIC DIAGNOSTIC APPARATUS AND CONTROL PANEL THEREOF

(75) Inventors: Qianquan HAN, Shenzhen (CN); Zhaoquan LIU, Shenzhen (CN)

Correspondence Address: MINDRAY C/O STOEL RIVES LLP, 201 S. MAIN STREET, SUITE 1100, SALT LAKE CITY, UT, 84111, US

(73) Assignee: SHENZHEN MINDRAY BIO-MEDICAL ELECTRONICS CO., LTD., Shenzhen (CN)

(21) Appl. No.: 12/264,795

(22) Filed: Nov. 4, 2008

(30) Foreign Application Priority Data
Dec. 19, 2007 (CN) 200710125237.2

(51) Int. Cl. G06F 3/045; G06F 3/041

(52) U.S. Cl. 345/174; 345/173

(57) ABSTRACT

An ultrasonic diagnostic apparatus includes a control panel for human-computer interaction, and a signal processing and managing unit. The control panel comprises a cover facing a user and arranged in a sealed manner, and at least one touch function unit. At least one function mark is displayed on the cover. Each touch function unit corresponds to the position of each function mark, which serves for sensing the user's operations, converting the user's operation information into the specific coded signals, and sending the coded signals to the signal processing and managing unit. A control panel is also disclosed. The products of the present disclosure have advantages that include low cost, long service life, and good sealing performance.

### RELATED APPLICATIONS

The present application claims priority to Chinese Patent Application No. 200710125237.2, filed Dec. 19, 2007, which is hereby incorporated by reference herein in its entirety.

### TECHNICAL FIELD

The present disclosure relates to an ultrasonic diagnostic apparatus, and particularly to a control panel for a human-computer interface of the ultrasonic diagnostic apparatus.

### SUMMARY

An ultrasonic diagnostic apparatus includes a control panel, and a signal processing and management unit. The control panel includes a cover accessible by a user and arranged in a sealed manner. At least one function mark may be displayed on the cover. The control panel may also include at least one touch function unit that corresponds to the position of a respective function mark.

### BRIEF DESCRIPTION OF THE DRAWINGS

FIG. 1 is a block diagram of an ultrasonic diagnostic apparatus according to one embodiment.

FIG. 2 is a structural diagram of a touch function unit according to one embodiment.

### DETAILED DESCRIPTION

An ultrasonic diagnostic apparatus is one of three main imaging devices used in a hospital. A control panel, as a human-computer interface device for the ultrasonic diagnostic apparatus, generally includes universal alphanumeric keys, a slide potentiometer for adjusting time gain compensation (TGC or TGC Sliders), an encoder for adjusting gains or menu knobs, a trackball for moving cursors, and function keys (for example, a Cineloop) peculiar to the ultrasonic apparatus, as well as a backlight control for the control panel. As compared with universal personal computers (PCs) in terms of functions, the alphanumeric keys are similar to a PC keyboard and the trackball is similar to a PC mouse; while the remaining elements are ultrasound specific input devices.

The control panel of a known ultrasonic diagnostic apparatus uses mechanical contact-type keys, uses a variable resistor to adjust TGC, uses the mechanical trackball to complete the operation of selecting positions, and uses the encoder to select functions. With the rapid development of use for the ultrasonic diagnostic apparatus, these traditional technologies increasingly fall behind the requirements of practical use. For example, while some special keys need to be used hundreds of thousands of times, it is hard for the mechanical keys to meet such a requirement. As another example, it is easy for the mechanical trackball to gather dust, which may require the after-sale engineer to make periodical maintenance visits to the customers. This results in the increasing maintenance cost of the apparatus.

The cost of the typical encoder is very high and its overall dimension has great effect on the shape of the control panel. Thus, it is disadvantageous to exchange the different encoders. In addition, with the development of the veterinary ultrasonic diagnostic apparatus, the traditional control panel has weak liquid proof ability, which can easily result in failure of the control panel, even safety accidents, when exposed to liquid.

In summary, the known ultrasonic diagnostic apparatus has the several disadvantages, including the following:

(1). High cost: the unit prices of the encoder and the trackball that can be used in medical equipment are very high, which increases the product cost of the control panel. Further, it is easy for the trackball to go failure due to dust, thereby increasing the periodic maintenance cost.

(2). Inadequate service life: the implementation principle of the traditional control panel determines its short service life, which is greatly shortened in the case of severe conditions. This can not match with the service life of the whole ultrasonic diagnostic apparatus. Thus, it is generally required to greatly increase the service life of the control panel, with no increase in cost.

(3). Weak liquid proof ability: the traditional control panel has a lower proof grade against liquid. In general, the typical control panel can be free from secure breakdown only in the case of invasion of a small amount of liquid. Thus, the appearance of all kinds of ultrasonic diagnostic apparatus put forwards a higher requirement on the liquid proof ability of the control panel.

The embodiments of the present disclosure provide an ultrasonic diagnostic apparatus and a control panel thereof. As disclosed herein, a control panel is used so as to lower the produce cost and the maintenance cost of the ultrasonic diagnostic apparatus, many or all of the keys and the function control devices on the panel can meet the current service life requirement, and the control panel is water proof.

In certain embodiments, an ultrasonic diagnostic apparatus comprises a control panel for human-computer interaction. The ultrasonic diagnostic apparatus also includes a signal processing and managing unit. The control panel comprises a cover accessible by a user and arranged in a sealed manner. The control panel also comprises at least one touch function unit. At least one function mark is displayed on the cover and each touch function unit corresponds to the position of each function mark, respectively. The touch function unit is configured for sensing the user's operations, converting the user's operation information into the specific coded signals, and sending the coded signals to the signal processing and managing unit.

Certain embodiments also provide a control panel for use in the ultrasonic diagnostic apparatus. The control panel comprises a cover accessible by a user and arranged in a sealed manner. The control panel also comprises at least one touch function unit, wherein at least one function mark is displayed on the cover and each touch function unit corresponds to the position of each function mark. The touch function unit is configured for sensing the user's operations and converting the user's operation information into the specific coded signals.

Among other things, the embodiments disclosed herein are:

(1). Low cost: the touch control panel uses the touch-sensitive control chip to complete its functions, without other peripheral equipments, thereby lowering the cost.

(2). Long service life: the service life of the control panel is longer than that of the ordinary control panel, since the touch technology makes use of electrical characteristics to complete all kinds of functions, without the direct mechanical impact.

(3). Good in sealing performance: the proof abilities against all kinds of liquid and dust are greatly improved.

The characteristics and advantages of the present disclosure will be described below with reference to the embodiments and the accompanying drawings.

The ultrasonic diagnostic apparatus described in the present disclosure comprises a control panel for human-computer interaction and a signal processing and managing unit. The control panel is configured to receive the user's operations, generate the corresponding operation information and send the operation information to the signal processing and managing unit.

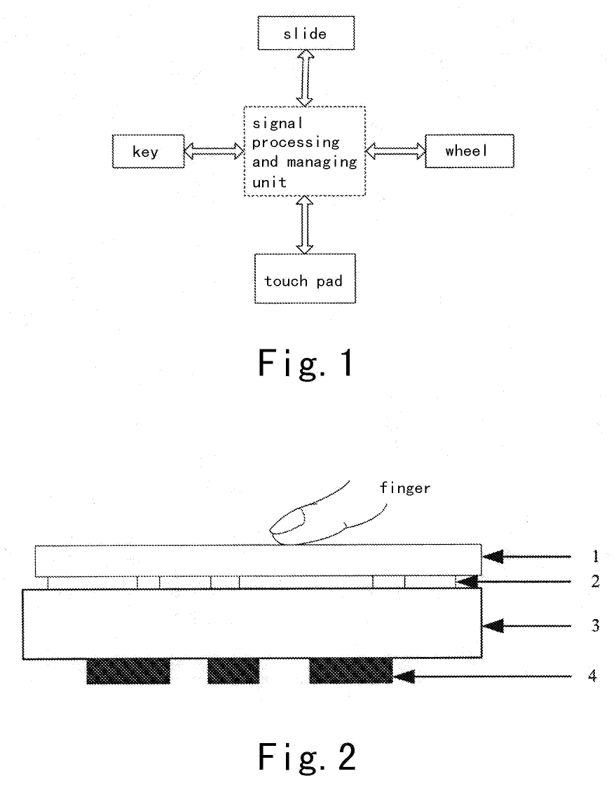

The basic structure of the functional circuit to be achieved in the present disclosure is shown in FIG. 1. The control panel is a touch-type control panel comprising a cover accessible by the user and arranged in a seal manner. The control panel also comprises at least one touch function unit. Each touch function unit corresponds to the position of each function mark, respectively. The touch function unit is configured for sensing the user's operations, converting the user's operation information into the specific coded signals, and sending the coded signals to the signal processing and managing unit. The touch function unit comprises a touch key, a touch slide, a touch wheel, and a touch pad. The real line portions in FIG. 1 indicate the touch keys, the touch slides, the touch wheels, and the touch pad, which are implemented by the touch technology. The dotted portion in FIG. 1 indicates the signal processing and managing unit.

The touch keys of the touch control panel comprise the ordinary alphabetic keys and the keys peculiar to the medical equipments. In one embodiment, all the keys are independently distributed, either in response to the action of pressing down a single key independently, or as a combination key in response to a plurality of keys simultaneously. However, all the operations in certain embodiments require the finger to directly press on the control panel.

The slide of the control panel serves for completing the input of absolute variation in the medical equipment, and such input generally needs to be continuously changeable within a range. In one embodiment, a change minimum unit and a change rate have a certain (predetermined) requirement. Thus, the finger may be required to slide on the corresponding position of the control panel when operating.

The wheel of the control panel serves for completing the input of relative variation of the medical equipment. Such input has no requirement on the signal changing range according to one embodiment. In addition, or in another embodiment, the wheel input has a certain (predetermined) requirement on the change minimum unit and the change rate, and the finger may be required to slide on the corresponding position of the control panel when operating.

The touch pad of the control panel serves, for example, for completing the plane positioning and a small amount of key operations. The positioning operation outputs a plane distance (e.g., horizontal distance and vertical distance) relative to a previous location. The key operations complete the response to the single click and double clicks of two keys.

In certain embodiments, each touch function unit in FIG. 1 comprises a sensor and a processor connected with the sensor. The sensor corresponds to the relevant mark of the cover for sensing the user's operations and continuously sending the user's operation information to the processor. The processor is used for generating the specific coded signals according to the received operation information. The processor converts the various operations corresponding to the control panel into signals coded according to certain rules and sends the signals to the signal processing and managing unit shown in the dotted portion of FIG. 1. The signal processing and managing unit, after converting these signals again, makes the corresponding response according to the specific operations. There are various sensors, such as the capacitive sensor or other sensors well known to a person skilled in the art.

FIG. 2 is a working principle constructed profile of the touch function unit according to one embodiment. A cover 1 shown in FIG. 2 may be any type of insulating materials, which thickness and material quality are tightly related with the area size and realized function of a sensor 2. The sensor 2 is the sensing material corresponding to the key, slide, wheel and touch pad. The area of the sensor 2 is related with the function to be realized. However, in a general case, the area of the sensor falls into a certain range so that the sensor can correctly sense the finger's actions. A printed circuit board (PCB) 3 is used for connecting the sensor 2 and a processor 4. In certain embodiments, there is no requirement for the thickness of the PCB 3, which can be determined according to the practical conditions. The processor 4 usually is a chip or several chips for processing the signals sensed by the sensor 2 and converting the various signals from the sensor 2 into signals that can be read by the signal processing and managing unit.

When the finger is close to the key by a certain distance, the sensor 2 can generate a corresponding signal and send the signal to the processor 4. The processor 4 converts this action of the finger into a specific coded signal so as to indicate an effective operation of pressing down the key. When the finger is away from the key by a certain distance, the sensor 2 also can generate another corresponding signal and send the signal to the processor 4. The processor 4 converts this action of the finger into a specific coded signal so as to indicate an effective operation of releasing the key. An effective make-code and break-code of the key can be formed by these kinds of operation.

When the finger is put on the cover 1 at a position corresponding to the slide, the sensor 2 generates a signal of the finger pressing down to indicate the current position of the finger. When the finger moves along the slide, the sensor 2 senses the actual position where the finger touches the slide to generate corresponding signals. The signals are continuously sent to the processor 4. The processor 4, after processing the signals, stores them. When the finger is away from the slide by a certain distance, the processor 4 converts this action of the finger and the stored signals together into a relative movement distance and forms specific coded signals corresponding to the relative movement distance.

When the finger is put on the cover 1 at a position corresponding to the wheel and rotates the wheel, the sensor 2 continuously sends the finger's movement information to the processor 4, converting it into a relative movement distance. The processor 4 converts these signals into the specific coded signals.

Different from the fact that the slide and the wheel merely output one-dimensional movement information, the touch pad in one embodiment outputs abscissa-ordinate two-dimensional information. Moreover, the touch pad has the key operating function. When the finger is put on the cover 1 at a position corresponding to the touch pad, the sensor 2 generates a signal of the finger pressing down and two-dimensional position information of the finger. When the finger slides on the touch pad, the sensor 2 sends the finger's movement information to the processor 4 continuously, which information contains the horizontal-longitudinal axis two-dimensional information. The processor 4 forms the information into the specific coded signals. When the finger is away from the touch pad by a certain distance, the sensor 2 sends the finger's action information to the processor 4, and the processor 4 forms it into the specific coded information.

As shown in FIG. 2, the outmost cover 1, which is formed of a corrosion-resistant insulating material according to one embodiment, directly makes contact with the finger and the surrounding. The outmost cover 1 can, after being formed into a whole, prevent outer dust, liquid, etc. from damaging the sensor 2, PCB 3, and so on, such that the control panel's abilities against dust and liquid are improved.

During practical operation, the control panel of the present disclosure is free from failure as a result of mechanical breakdown, since it is configured without the traditional mechanical actions, such as the key being pressed down or springing up, or the friction of the potentiometer. The control panel's service life is restricted only by the electronic devices. Therefore, the service life of the touch control panel is greatly longer than that of the traditional control panel.

In certain embodiments, the touch control panel leaves out the peripheral equipments such as encoder, trackball, as well as the moulds, cables, and receptacles, which are required by the keys. Thereby, its production cost is greatly lower than that of the traditional control panel. Moreover, the touch control panel is configured without the electromechanical trackball to avoid frequent maintenance and repair tasks, so that the maintenance is lowered.

It will be understood by those having skill in the art that many changes may be made to the details of the above-described embodiments without departing from the underlying principles of the invention. The scope of the present invention should, therefore, be determined only by the following claims.

What is claimed is:

1. An ultrasonic diagnostic apparatus comprising:
a control panel for human-computer interaction; and
a signal processing and managing unit;
wherein the control panel comprises:
a cover accessible by a user and arranged in a sealed manner, on which cover at least one function mark is displayed; and
at least one touch function unit, each touch function unit corresponds to the position of each function mark, respectively;
wherein the touch function unit is configured for sensing the user's operations with respect to the cover, converting the user's operation information into specific coded signals, and sending the coded signals to the signal processing and managing unit.

2. The ultrasonic diagnostic apparatus according to claim 1, wherein the touch function unit comprises:
a sensor; and
a processor in communication with the sensor;
wherein the sensor is configured for sensing the user's operations with respect to the cover and continuously sending the user's operation information to the processor; and
wherein the processor is configured for generating the specific coded signals according to the received operation information.

3. The ultrasonic diagnostic apparatus according to claim 2, wherein the sensor comprises a capacitive sensor.

4. The ultrasonic diagnostic apparatus according to claim 3, wherein the touch function unit further comprises a touch key; the sensor corresponding to a key mark on the cover for sensing the operations of the user approaching/touching the key and being away from the key, generating the corresponding operating signals, and sending the operating signals to the processor.

5. The ultrasonic diagnostic apparatus according to claim 3, wherein the touch function unit further comprises a touch slide; the sensor corresponding to a slide mark on the cover for sensing the actual position at which the user touches the slide, generating the corresponding position signals and sending the position signals to the processor; and the processor converts the position signals into a relative movement distance, forming the specific coded signals.

6. The ultrasonic diagnostic apparatus according to claim 3, wherein the touch function unit further comprises a touch wheel; the sensor corresponding to a wheel mark on the cover for sensing movement information that the user makes on the wheel and continuously sending the movement information to the processor; and the processor converts the movement information into a relative movement distance, forming the specific coded signals.

7. The ultrasonic diagnostic apparatus according to claim 3, wherein the touch function unit further comprises a touch pad; the sensor corresponding to a display screen mark on the cover for sensing the pressing, departing and sliding operations of the user on the display screen, generating the corresponding operating information and two-dimensional position information of the operating position, and sending all the information to the processor; and the processor generates the specific coded signals according to the operating information and the two-dimensional position information.

8. The ultrasonic diagnostic apparatus according to claim 3, wherein the cover comprises corrosion-resistant insulating material.

9. A control panel for use in an ultrasonic diagnostic apparatus, the control panel comprising:
a cover accessible by a user and arranged in a sealed manner; and
at least one touch function unit;
wherein at least one function mark is displayed on the cover;
wherein each touch function unit corresponds to the position of each function mark; and
wherein the touch function unit is configured for sensing the user's operations with respect to the cover and converting the user's operation information into specific coded signals.

10. The control panel according to claim 9, wherein the touch function unit comprises:
a sensor; and
a processor connected with the sensor;
wherein the sensor is configured for sensing the user's operations with respect to the cover and continuously sending the user's operation information to the processor; and
wherein the processor is configured for generating the specific coded signals according to the received operation information.
